(19) United States
(12) Patent Application Publication
(10) Pub. No.: US 2017/0232757 A1
(43) Pub. Date: Aug. 17, 2017

(54) LIQUID CONTAINER, LIQUID JET APPARATUS

(71) Applicant: SEIKO EPSON CORPORATION, Tokyo (JP)

(72) Inventor: Takumi KOBAYASHI, Matsumoto-shi (JP)

(73) Assignee: SEIKO EPSON CORPORATION, Tokyo (JP)

(21) Appl. No.: 15/429,774

(22) Filed: Feb. 10, 2017

(30) Foreign Application Priority Data
Feb. 12, 2016 (JP) 2016-024691

(51) Int. Cl. B41J 2/19

(52) U.S. Cl. CPC B41J 2/19

(57) ABSTRACT

Provided is a liquid container and a liquid jet apparatus to which liquid liquid inlet portion can be supplied stably. The liquid container includes: a liquid containing chamber; an air communication portion connecting an air introduction port for introducing air into the liquid containing chamber with an air exposing port; a liquid inlet portion; and a liquid discharging portion configured to discharge the liquid to the liquid ejection head. The liquid containing chamber has a viewing portion that makes it possible to view a liquid surface from outside, and a lower limit display portion that serves as a reference for replenishing the liquid in the liquid containing chamber. The air introduction port is located at a position that is lower than the lower end of the inlet opening, is lower than a position of the end surface of a nozzle, and is higher than a position of the lower limit display portion.

### BACKGROUND

### 1. Technical Field

The present invention relates to a liquid container capable of containing a liquid such as ink injected therein, and a liquid jet apparatus such as an inkjet printer that ejects a liquid supplied from the liquid container.

### 2. Related Art

There has been known to be a liquid jet system (liquid jet apparatus) including an ink tank (liquid container) in which a liquid injection path (liquid inlet portion) for injecting ink (a liquid) into a liquid containing chamber is formed (e.g., JP-A-2011-240705). Also, the ink tank discharges ink that was injected through the liquid injection path and is contained in the liquid containing chamber from a liquid discharging portion formed in a bottom surface wall, and thus supplies the ink to a recording head (liquid ejection head).

Also, an air introduction port, which is one end of an air exposing flow path (air communication portion) having another end in communication with an atmosphere, is formed at the bottom surface wall. For this reason, when the amount of liquid in the liquid containing chamber decreases due to the liquid being discharged from the liquid discharging portion, air is introduced through the air introduction port, and a suitable hydraulic head difference is maintained between the ink tank and the recording head.

JP-A-2011-240705 is an example of related art.

Incidentally, since the air introduction port is formed in the bottom surface wall, the air is introduced as air bubbles. For this reason, when the liquid surface of the ink approaches the bottom surface wall due to the ink in the liquid containing chamber being discharged, there is a risk that air bubbles introduced through the air introduction port will be discharged through the liquid discharging portion together with the ink, and the supplying of the ink will become unstable.

Note that this problem is not limited to an ink tank and a liquid jet system for ejecting ink supplied from an ink tank, and is roughly the same for a liquid container and a liquid jet apparatus that ejects a liquid supplied from a liquid container.

### SUMMARY

An advantage of some aspects of the invention is providing a liquid container and a liquid jet apparatus according to which liquid injected from a liquid inlet portion can be supplied stably.

The following describes means for solving the above issues, and actions effects of such means.

A liquid supply apparatus that solves the foregoing problems is a liquid container including: a liquid containing chamber capable of containing a liquid to be supplied to a liquid ejection head that ejects the liquid from a nozzle; an air communication portion that allows an air introduction port for introducing air into the liquid containing chamber and an air communication port open to the atmosphere to be in communication; a liquid inlet portion at which a liquid can be injected through an inlet opening that opens into the liquid containing chamber; and a liquid discharging portion configured to discharge the liquid to the liquid ejection head from a liquid outlet provided on a bottom surface of the liquid containing chamber, wherein the liquid containing chamber includes: a viewing portion that is provided on a wall forming the liquid containing chamber and makes it possible to view a liquid surface in the liquid containing chamber from outside; and a lower limit display portion that is provided on the viewing portion and serves as a reference for replenishing the liquid in the liquid containing chamber, and the air introduction port is located at a position that is lower than a lower end of the inlet opening in the height direction, is the same as or lower than a position in the height direction of an end surface of the nozzle, and is the same as or higher than a position in the height direction of the lower limit display portion.

If the liquid surface is higher than the air introduction port, the air introduced through the air introduction port will be air bubbles, whereas if the liquid surface is lower than the air introduction port, the air will be directly introduced into the space above the liquid surface. Also, according to this configuration, the air introduction port is located a position that is the same as or higher than the position in the height direction of the lower limit display portion. For this reason, if the liquid surface is higher than the air introduction port, air bubbles will be introduced through the air introduction port, but since the liquid surface and the liquid outlet are located apart from each other, the air bubbles are not likely to be discharged from the liquid discharging portion. Also, if the liquid surface is lower than the air introduction port, the air is introduced directly into the space above the liquid surface, and therefore air bubbles are not likely to be formed. Accordingly, since it is possible to reduce the risk that air bubbles will be discharged from the liquid discharging portion, the liquid injected through the liquid inlet portion can be supplied stably.

In the liquid container, it is preferable that the air communication portion includes a space portion having a predetermined volume.

According to this configuration, the air communication portion includes a space portion, and therefore even if liquid flows out from the liquid containing chamber to the air communication portion side due to a change in temperature, pressure, or the like, for example, the liquid that flowed out can be received in the space portion. That is, it is possible to reduce the risk that the liquid will leak from the air exposing port.

In the liquid container, it is preferable that at least a portion of the viewing portion is located at a position that is lower than a lower end of the inlet opening in the height direction.

According to this configuration, the viewing portion is located at a position lower than the lower end of the inlet opening, and therefore the liquid surface, which is displaced at a position that is lower than the inlet opening, can be viewed. In other words, the liquid surface is displaced at a position lower than the inlet opening, and therefore it is possible to reduce the risk that the liquid will leak from the inlet opening compared to the case where the liquid surface is displaced at a position higher than the inlet opening.

In the liquid container, it is preferable that the liquid containing chamber has an upper limit display portion that is provided on the viewing portion and serves as a reference for an upper limit of the liquid contained in the liquid containing chamber.

According to this configuration, it is possible to reduce the risk that the liquid will overflow by injecting the liquid through the liquid inlet portion using the upper display portion as a reference.

In the liquid container, it is preferable that the air introduction port is located at a position lower than the upper limit display portion in the height direction.

According to this configuration, the air introduction portion is located between the lower limit display portion and the upper limit display portion in the height direction. For this reason, if the position of the liquid surface is high and the hydraulic head with respect to the liquid ejection head is high, the liquid can be supplied stably using the principle of Mariotte's bottle. Also, if the position of the liquid surface lowers due to the liquid being supplied, and the hydraulic head with respect to the liquid ejection head decreases, the liquid surface is located at a position lower than that of the air introduction port, and therefore the liquid can be supplied while the formation of air bubbles is supressed.

Also, a liquid jet apparatus that solves the foregoing problems includes: the liquid container having the above-described configuration; the liquid ejection head; and a supply portion configured to supply the liquid contained in the liquid containing chamber to the liquid ejection head.

According to this configuration, an effect similar to that achieved by the above-described liquid container can be demonstrated.

### BRIEF DESCRIPTION OF THE DRAWINGS

The invention will be described with reference to the accompanying drawings, wherein like numbers reference like elements.

FIG. 1 is a perspective view of a first embodiment of a liquid jet apparatus including a liquid container.

FIG. 2 is a perspective view of a liquid supply unit in an injection orientation.

FIG. 3 is a perspective view of a liquid container.

FIG. 4 is a side view of a liquid container in the injection orientation in a view from an opening side thereof.

FIG. 5 is a side view of a liquid container in the supply orientation in a view from an opening side thereof.

FIG. 6 is a side view of a liquid container in which the liquid surface has dropped to the air introduction port, in a view from an opening side thereof.

### DESCRIPTION OF EXEMPLARY EMBODIMENTS

Hereinafter, an embodiment of a liquid jet apparatus including a liquid container will be described with reference to the drawings. Note that the liquid jet apparatus of the present embodiment is a printer that ejects ink, which is an example of a liquid, to a medium such as a sheet, and thereby prints (records) text, an image, or the like on the medium.

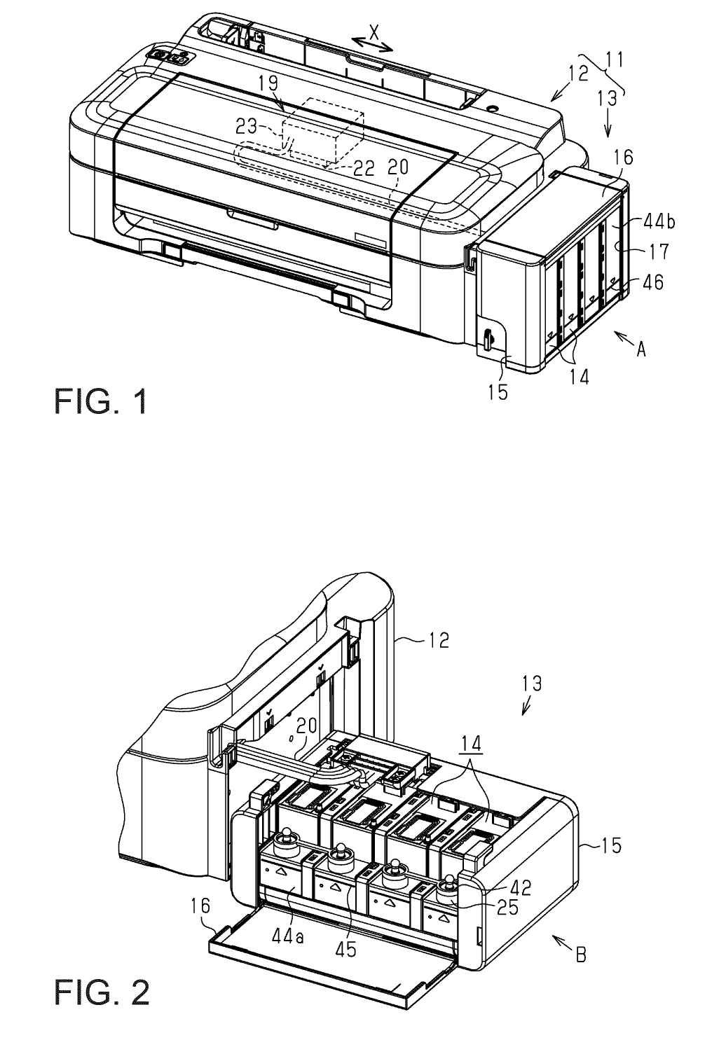

As shown in FIG. 1, a liquid jet apparatus 11 includes an apparatus body 12 that has an approximately cuboid shape, and a liquid supply unit 13 that is mounted on a side surface in the longitudinal direction of the apparatus body 12. The liquid supply unit 13 includes at least one (in the present embodiment, four) liquid container 14 and a cover 15 that covers the liquid container 14. In other words, liquid containers 14 are attached to the outer side of a housing of the apparatus body 12 of the liquid jet apparatus 11 of the present embodiment. Also, the cover 15 has a lid portion 16 provided so as to be able to open and close, and a checking window portion 17 for checking the remaining amounts of liquid that can be supplied from the liquid containers 14.

The apparatus body 12 is provided with a printing portion 19 that performs printing by attaching the liquid to a medium (not shown) and supply portions 20 such as tubes that supply the liquid from the liquid supply unit 13 to the printing portion 19. Note that one supply portion 20 is connected to each liquid container 14, but only one supply portion 18 is shown in FIG. 1 for the sake of simplicity in the drawing.

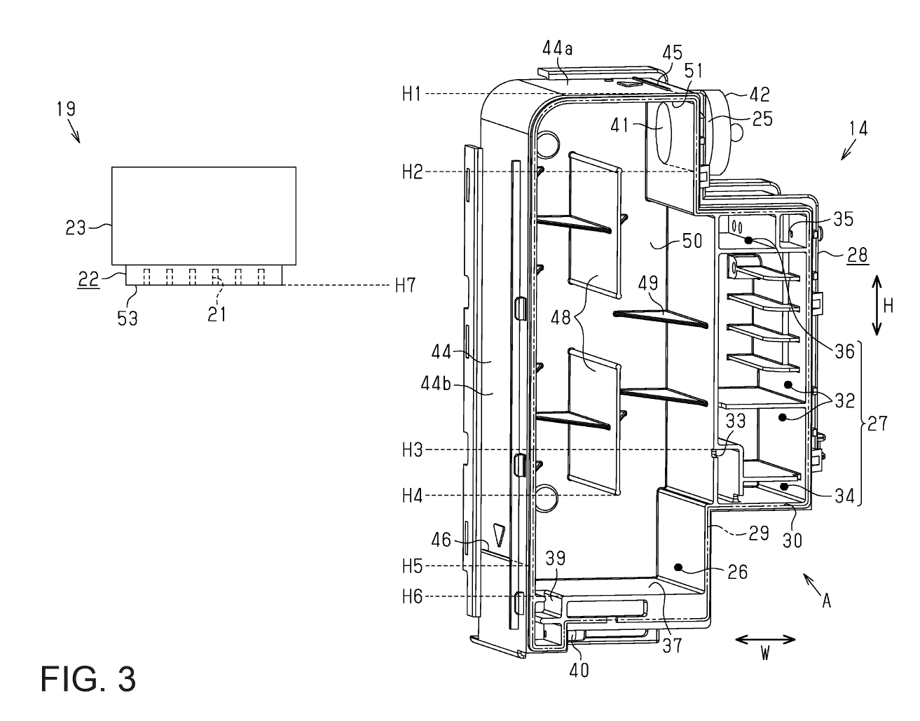

The printing portion 19 includes a liquid ejection head 22 that ejects the liquid from a nozzle (see FIG. 3) 21, and a carriage 23 that moves the liquid ejection head 22 reciprocally along a scanning direction X, which matches the longitudinal direction of the apparatus body 12. In other words, the printing portion 19 performs printing on the medium by ejecting the liquid to the medium from the liquid ejection head 22, which moves reciprocally along the scanning direction X.

As shown in FIGS. 1 and 2, the liquid supply unit 13 is detachably mounted on the apparatus body 12, and the orientation of the liquid supply unit 13 can be changed. In other words, by being mounted on the apparatus body 12 in a supply orientation A shown in FIG. 1, the liquid supply unit 13 and the liquid containers 14 enter a supply state in which the liquid can be supplied to the liquid ejection head 22. Then, as shown in FIG. 2, after being taken out of the apparatus body 12, the liquid supply unit 13 and the liquid containers 14 are laid on their sides such that the viewing window portion 17 is hidden, and the liquid supply unit 13 and the liquid containers 14 are put in the injection orientation B and thus enter the injection state in which the liquid can be injected into the liquid containers 14.

Also, in the case where the liquid containers 14 are in the supply orientation A, the lid portion 16 is located at the closed position shown in FIG. 1 and covers the liquid containers 14. Also, in the case where the liquid containers 14 are in the injection orientation B, the lid portion 16 is located at the open position shown in FIG. 2 and the liquid inlet portions 25 included in the liquid containers 14 are exposed to the outside.

Next, the liquid containers 14 will be described. Note that different types (e.g., four colors, namely cyan, magenta, yellow, and black) of liquid are injected into the respective liquid containers 14, but the configurations thereof are the same. For this reason, one liquid container 14 will be described, the same reference numerals will be used for each liquid container 14, and redundant description will not be included. Also, as shown in FIG. 3, in the liquid container 14 in the supply orientation A, the direction along the vertical direction is the height direction H of the liquid container 14, and the direction intersecting the height direction H is the width direction W.

As shown in FIG. 3, the liquid container 14 is constituted by including a container case 28 in the form of a bottomed box, which includes a liquid containing chamber 26 capable of containing a liquid to be supplied to the liquid ejection head 22 and an air communication portion 27 that allows the liquid containing chamber 26 and the atmosphere to be in communication, and a container forming film 29. Specifically, the container case 28 is obtained by integrally forming five surfaces, and by attaching the container forming film 29 to the container opening 30 of the container case 28, the liquid containing chamber 26 and the air communication portion 27 are integrally formed. Note that in the present embodiment, the container opening 30 has a rib shape formed on its entire periphery along the outer shape of the container case 28, and the container forming film 29 is welded to the container opening 30.

The air communication portion 27 includes an air chamber 32, which is an example of a space portion having a predetermined volume, a communication path 34 that allows the air introduction port 33 for introducing air into the liquid containing chamber 26 and the air chamber 32 to be in communication, and an air flow path 36 that allows an air exposing port 35 that is open to the atmosphere and the air chamber 32 to be in communication. In other words, the air communication portion 27 allows the air introduction port 33 and the air exposing port 35 to be in communication. Note that the air introduction port 33 is formed so as to be located away from the bottom surface 37 of the liquid containing chamber 26.

Also, the predetermined volume of the air chamber 32 is a volume that is larger than the volume of the communication path 34 and is larger than the volume of the air flow path 36. More specifically, the volumes of the communication path 34 and the air flow path 36 in the present embodiment are each smaller than the volume of the liquid inlet portion 25, and the volume of the air chamber 32 is larger than the volume of the liquid inlet portion 25. Note that the volume of the air chamber 32 of the present embodiment is smaller than the volume of the liquid containing chamber 26, but may be greater than or equal to the volume of the liquid containing chamber 26.

Furthermore, the liquid container 14 includes a liquid discharging portion 40 that discharges the liquid from a liquid outlet 39 provided at the bottom surface 37 of the liquid containing chamber 26 to the liquid ejection head 22. In other words, the supply portion 20 included in the liquid jet apparatus 11 is connected to the liquid discharging portion 40, and the supply portion 20 supplies the liquid contained in the liquid containing chamber 26 to the liquid ejection head 22.

Also, the liquid inlet portion 25 at which the liquid can be injected through an inlet opening 41 that opens in the liquid containing chamber 26 is formed into a tube shape so as to protrude from the liquid containing chamber 26 in the width direction W. Furthermore, a closing member 42 is detachably attached to the liquid inlet portion 25. That is, the liquid containing chamber 26 is in an air-tight state due to the closing member 42 being attached to the liquid inlet portion 25.

Note that in the liquid container 14 in the supply orientation A, the liquid outlet 39 is formed at a position located at the lower end of the liquid containing chamber 26 in the height direction H. Furthermore, the inlet opening 41 is formed at a position located at the upper end in the height direction H.

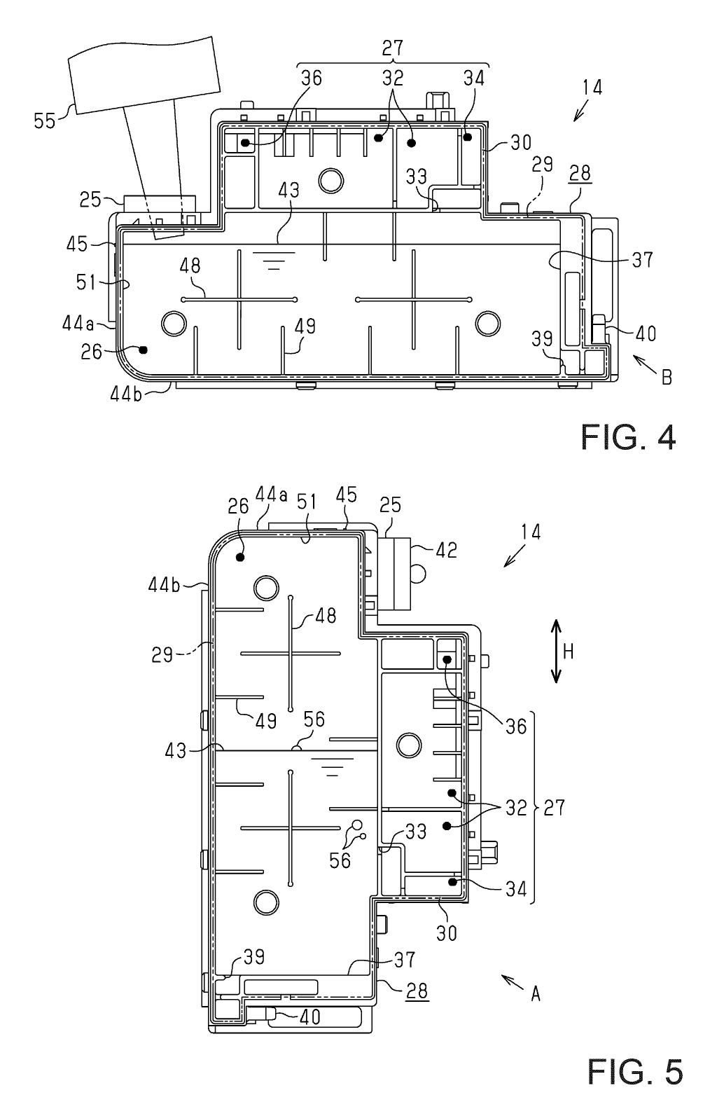

Also, the container case 28 is made of transparent or translucent resin, and the liquid contained in the liquid containing chamber 26 can be viewed from the outside of the liquid container 14. For this reason, the liquid containing chamber 26 has the viewing portion 44 that is provided on a wall forming the liquid containing chamber 26, and that makes it possible to view the liquid surface (see FIG. 4) 43 in the liquid containing chamber 26 from the outside.

Note that the viewing portion 44 has a first viewing portion 44a that is covered by the lid portion 16 located in the closed position and is exposed to the outside due to the lid portion 16 being located in the open position, and a second viewing portion 44b, which is a region corresponding to the checking window portion 17. In other words, the first viewing portion 44a is provided on an upper wall of the liquid containing chamber 26. Also, the second viewing portion 44b is provided on a side wall of the liquid containing chamber 26.

Also, the liquid containing chamber 26 includes an upper limit display portion 45 that is provided on the first viewing portion 44a and serves as a reference for the upper limit of the liquid contained in the liquid containing chamber 26, and a lower limit display portion 46 that is provided on the second viewing portion 44b and serves as a reference for replenishing the liquid in the liquid containing chamber 26. Note that the lower limit display portion 46 and the upper limit display portion 45 of the present embodiment are formed so as to protrude from the surface on which the viewing portion 44 is provided.

In the liquid containing chamber 26, at least one each (in the present embodiment, a plurality) of a vertical rib portion 48 formed so as to conform to the direction (height direction H) intersecting the horizontal direction, and a horizontal rib portion 49 formed so as to conform to the width direction W are formed. Note that the vertical rib portion 48 and the horizontal rib portion 49 are formed integrally with the container case 28 so as to protrude from a far surface 50 that intersects with the bottom surface 37. Also, the dimension from the base end to the leading end of the vertical rib portion 48 is approximately equal to the dimension from the container opening 30 to the far surface 50. For this reason, when the container forming film 29 is attached to the container opening 30, the container forming film 29 is attached to the leading end surfaces of the vertical rib portions 48 as well. That is, the liquid containing chamber 26 is partitioned by the vertical rib portions 48, and the regions partitioned by the vertical rib portions 48 are in communication via the gaps between the vertical rib portions 48 and the bottom surface 37, the gaps between the vertical rib portions 48, and the gaps between the vertical rib portions 48 and the ceiling surface 51.

Also, the air introduction port 33 is located at a position between the lower end and the upper end of the vertical rib portion 48 located at the lowest position (bottom surface 37 side) in the height direction H among the multiple vertical rib portions 48. Also, among the regions partitioned in the width direction W by the vertical rib portions 48, the liquid outlet 39 is provided in a region on the second viewing portion 44b side, and the air introduction port 33 is provided in another region on the air communication portion 27 side.

Next a positional relationship between the liquid container 14 and the liquid ejection head 22 in a state where the liquid container 14 is assembled in the liquid supply unit 13 and the liquid supply unit 13 is mounted in the apparatus body 12 will be described.

Note that as shown in FIG. 3, the position of the upper limit display portion 45 in the height direction H of the liquid container 14 is an upper limit position H1, and the position of the lower end of the inlet opening 41 of the liquid container 14 is an injection position H2. Note that the upper limit position H1 and the injection position H2 are located at positions higher than (above) the center of the liquid containing chamber 26 in the height direction H. Furthermore, in descending order of height in the height direction H, the position of the upper end of the air introduction port 33 is an air introduction position H3, the position of the lower end of the vertical rib portion 48 is a rib position H4, the position of the lower limit display portion 46 is a lower limit position H5, and the position of the liquid outlet 39 is a liquid discharging position H6.

Also, the liquid container 14 is arranged such that the air introduction position H3 is located at a position lower than (below) a nozzle position H7 in the height direction H of the end surface 53 of the nozzle 21. In the case of comparing these positions in the following description, it is assumed that the positions in the height direction H are compared.

The liquid container 14 is arranged such that the injection position H2 is located at a position that is higher than the nozzle position H7. That is, the liquid container 14 is arranged such that the nozzle position H7 is located between the injection position H2 and the air introduction position H3. Also, at least a portion of the second viewing portion 44b of the liquid container 14 in the supply orientation A is located at a position lower than the injection position H2 in the height direction H.

More specifically, the lower limit position H5 is a position that is higher than the liquid discharging position H6 and is lower than the rib position H4. Also, the air introduction position H3 is a position that is higher than the liquid discharging position H6, the lower limit position H5, and the rib position H4. Furthermore, the air introduction position H3 is a position that is lower than the upper limit position H1 and the injection position H2.

In other words, the air introduction port 33 is provided at a position that is lower than the lower end of the inlet opening 41 in the height direction H. Furthermore, the air introduction port 33 is located at a position that is lower than the position (nozzle position H7) in the height direction H of the end surface 53 of the nozzle 21, is higher than the position (lower limit position H5) in the height direction H of the lower limit display portion 46, and is lower than the upper limit display portion 45 in the height direction H.

Next, an effect in the case of injecting the liquid into the liquid containing chamber 26 and supplying the liquid from the liquid container 14 to the liquid ejection head 22 will be described.

As shown in FIG. 4, when the ink is to be injected (replenished) in the liquid containing chamber 26, the liquid supply unit 13 is taken out from the apparatus body 12 and placed in the injection orientation B. Upon doing so, the liquid inlet portion 25 of the liquid container 14 opens upward in the vertical direction and the air introduction port 33 of the liquid container 14 is located vertically higher than the upper limit display portion 45. Then, a bottle 55 containing the liquid to be injected is inserted into the liquid inlet portion 25 from which the closing member 42 has been removed, and the liquid is injected from the bottle 55 into the liquid containing chamber 26 using the upper limit display portion 45 as a reference. Upon the liquid being injected into the liquid containing chamber 26, the liquid inlet portion 25 is closed by the closing member 42. In order words, the liquid containing chamber 26 is put in an air-tight state, the liquid supply unit 13 is furthermore mounted in the apparatus body 12, and the liquid container 14 is placed in the supply orientation A.

As shown in FIG. 5, when the liquid is consumed by the liquid ejection head 22 accompanying maintenance of the liquid ejection head 22 or printing, liquid having a volume corresponding to the consumed volume is supplied from the liquid container 14 to the liquid ejection head 22. That is, the liquid container 14 discharges the liquid in the liquid containing chamber 26 from the liquid discharging portion 40.

Upon doing so, in the liquid containing chamber 26 in the air-tight state, a liquid surface 43 drops, the air in the liquid containing chamber 26 expands, and the pressure acting on the liquid surface 43 becomes a negative pressure. Meanwhile, since the air communication portion 27 communicates with the air exposing port 35, when the pressure acting on the liquid surface 43 becomes smaller than the atmospheric pressure, air (air bubbles 56) is introduced through the air introduction port 33. For this reason, the liquid in the liquid containing chamber 26 is stably supplied to the liquid ejection head 22 using the principle of Mariotte's bottle.

Also, it takes time for some air bubbles 56 to break, and thus some air bubbles 56 accumulate on the liquid surface 43. However, since the gap between the liquid surface 43 and the liquid outlet 39 in the height direction H is large, the air bubbles 56 on the liquid surface 43 are accumulated in a state in which they are not likely to be discharged from the liquid discharging portion 40.

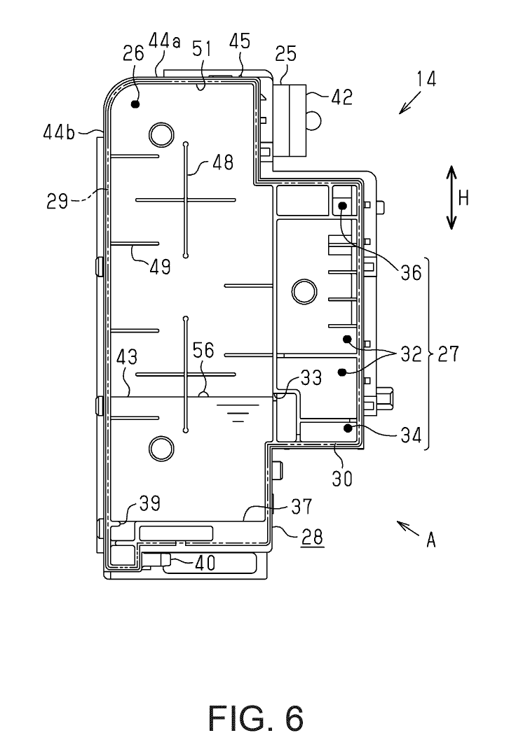

As shown in FIG. 6, when the liquid is furthermore supplied and the liquid surface 43 drops to the air introduction port 33, the space above the liquid surface 43 in the liquid containing chamber 26 and the air communication portion 27 communicate. For this reason, air bubbles 56 are not likely to be generated since the air is introduced directly to the space above the liquid surface 43 through the air introduction port 33. Also, even if an air bubble 56 that was formed in advance has not broken and remains at this time, the air bubble 56 will be accumulated at a region on the air introduction port 33 side with respect to the vertical rib portion 48. Accordingly, even if the gap between the liquid surface 43 and the liquid outlet 39 in the height direction H becomes small, liquid in which the mixing of air bubbles 56 is suppressed is discharged from the liquid discharge portion 40.

According to the above-described embodiment, the following effects can be obtained.

(1) If the liquid surface 43 is higher than the air introduction port 33, the air introduced through the air introduction port 33 will be air bubbles 56, whereas if the liquid surface 43 is lower than the air introduction port 33, the air will be introduced directly into the space above the liquid surface 43. Also, the air introduction port 33 is located at a position that is the same as or higher than the position in the height direction H of the lower limit display portion 46. For this reason, if the liquid surface 43 is higher than the air introduction port 33, air bubbles 56 will be introduced through the air introduction port 33, but the liquid surface 43 and the liquid outlet 39 will be located away from each other, and therefore the air bubbles 56 are not likely to be discharged from the liquid discharging portion 40. Also, if the liquid surface 43 is lower than the air introduction port 33, the air will be introduced directly into the space above the liquid surface 43, and therefore the air bubbles 56 are not likely to be formed. Accordingly, since it is possible to reduce the risk that the air bubbles 56 will be discharged from the liquid discharging portion 40, the liquid injected through the liquid inlet portion 25 can be supplied stably.

(2) Since the air communication portion 27 includes the air chamber 32, even if the liquid flows out from the liquid containing chamber 26 to the air communication portion 27 side due to a change in temperature, pressure, or the like, for example, the liquid that flowed out can be received in the air chamber 32. That is, it is possible to reduce the risk that the liquid will leak from the air exposing port 35.

(3) The second viewing portion 44b is located at a position lower than the lower end of the inlet opening 41, and therefore the liquid surface 43, which is displaced at a position lower than the inlet opening 41, can be viewed. In other words, the liquid surface 43 is displaced at a position lower than the inlet opening 41, and therefore it is possible to reduce the risk that the liquid will leak from the inlet opening 41 compared to the case where the liquid surface 43 is displaced at a position higher than the inlet opening 41.

(4) It is possible to reduce the risk that the liquid will overflow by injecting the liquid through the liquid inlet portion 25 using the upper limit display portion 45 as a reference.

(5) The air introduction port 33 is located between the lower limit display portion 46 and the upper limit display portion 45 in the height direction H. For this reason, if the position of the liquid surface 43 is high and the hydraulic head relative to the liquid ejection head 22 is high, the liquid can be supplied stably using the principle of Mariotte's bottle. Also, if the position of the liquid surface drops and the hydraulic head with respect to the liquid ejection head 22 becomes small due to the liquid being supplied, the liquid surface 43 is located at a position lower than the air introduction port 33, and therefore the liquid can be supplied while the formation of air bubbles 56 is suppressed.

(6) Among the regions partitioned by the vertical rib portion 48, the liquid outlet 39 is provided in one region, and the air introduction port 33 is provided in another region. Furthermore, the air introduction port 33 is located at a position higher than the lower end of the vertical rib portion 48. For this reason, even if the air is introduced as air bubbles 56 in a state in which the liquid surface 43 is located at a position higher than the air introduction port 33, the air bubbles 56 accumulate on the liquid surface 43 in the region in which the air introduction port 33 is provided. For this reason, it is possible to reduce the risk that the air bubbles 56 will be discharged from the liquid outlet 39.

Note that the above-described embodiment may be modified as follows.
In the above-described embodiment, the liquid jet apparatus 11 may be a built-in type in which the liquid supply unit 13 or the liquid containers 14 are arranged inside of a housing of the apparatus body 12.
In the above-described embodiment, the liquid outlet 39 may be provided on a side surface or the far surface 50 intersecting with the bottom surface 37 so as to be in contact with the bottom surface 37 of the liquid containing chamber 26.
In the above-described embodiment, the lower limit position H5 may be the same position as the liquid discharging position H6. That is, the lower limit display portion 46 may be provided at the same position as the bottom surface 37 of the liquid container 14 in the height direction H.
In the above-described embodiment, the injection position H2 may be the same position as the nozzle position H7. That is, the liquid container 14 may be arranged such that the lower end of the inlet opening 41 is located at the same position as the end surface 53 of the nozzle 21 in the height direction H.
In the above-described embodiment, the liquid container 14 may be arranged such that the air introduction position H3 is located at the same position as the nozzle position H7. That is, the air introduction port 33 may be at the same position as the position in the height direction H of the end surface 53 of the nozzle 21.
In the above-described embodiment, the air introduction position H3 may be the same position as the lower limit position H5. That is, the air introduction port 33 may be located at the same position as the position (lower limit position H5) in the height direction H of the lower limit display portion 46.
In the above-described embodiment, the rib position H4 may be a position lower than the lower limit position H5.
In the above-described embodiment, the air chamber 32 may be formed separately from the liquid containing chamber 26.
In the above-described embodiment, the predetermined volume of the air chamber 32 may be set according to the environment in which the liquid jet apparatus 11 and the liquid containers 14 are installed. For example, if the temperature of the location at which the liquid jet apparatus 11 and the liquid containers 14 are installed changes, the air inside the liquid containing chambers 26 expands or contracts and the pressure applied to the liquid surfaces 43 changes in some cases. That is, when a large amount of pressure (positive pressure) is applied to the liquid surface 43 due to the atmospheric pressure, for example, there is a risk that the liquid will flow out from the liquid containing chamber 26 via the air introduction port 33 and the communication path 34. In that respect, the communication path 34 is connected to the air chamber 32, and therefore the liquid that flows out from the liquid containing chamber 26 via the communication path 34 can be received by the air chamber 32. That is, it is possible to reduce the risk that the liquid will leak to the outside of the liquid container 14 by including the air chamber 32. Furthermore, the larger the temperature change is, the larger the amount of liquid that flows out from the liquid containing chamber 26 via the air introduction port 33 will be. For this reason, in the case of the liquid jet apparatus 11 and the liquid containers 14 being used in an environment with a large temperature change, for example, the volume of the air chamber 32 may be set to be larger compared to that of a liquid jet apparatus 11 and liquid containers 14 being used in an environment with a small temperature change.
In the above-described embodiment, the liquid inlet portion 25 may be provided so as to be open in a direction intersecting the horizontal direction (e.g., upward in the height direction H) when the liquid container 14 is in the supply orientation A. In other words, the orientation of the liquid container 14 need not be changed at a time of supply, when liquid is supplied to the liquid ejection head 22, and at a time of injection, when liquid is injection into the liquid containing chamber 26. Also, the upper limit display portion 45 may be provided on the second viewing portion 44b. Also, the air introduction portion 33 may be located at the same position as the upper limit display portion 45 in the height direction H or at a position higher than the upper limit display portion 45. Also, the first viewing portion 44a need not be provided.
In the above-described embodiment, the upper limit display portion 45 need not be provided.
In the above-described embodiment, the entirety of the second viewing portion 44b in which the lower limit display portion 46 is provided may be located at a position lower than the lower end of the inlet opening 41 in the height direction H. Also, the entirety of the second viewing portion 44b in which which the lower limit display portion 46 is provided may be located at a position higher than the lower end of the inlet opening 41 in the height direction H. In other words, the liquid inlet portion 25 may be located at a position lower than the second viewing portion 44b in the height direction H.
In the above-described embodiment, the air chamber 32 having the predetermined volume need not be provided. In other words, the air introduction port 33 and the air exposing port 35 may be connected by the communication path 34 or the air flow path 36.
In the above-described embodiments, the liquid jet apparatus 11 may be a liquid jet apparatus that ejects or discharges a liquid other than ink. Note that examples of the state of the liquid discharged as very small droplets from the liquid jet apparatus include a granular shape, a tear-drop shape, and a shape having a thread-like trailing end. Also, a liquid in this context need only be a material that can be ejected from the liquid jet apparatus. For example, it is sufficient to use a liquid in a state at a time when a substance is in the liquid phase, examples thereof including liquids with high or low viscosity, and fluids such as sols, gels, other inorganic solvents, organic solvents, solutions, liquid resins, and liquid metals (metallic melts). Examples also include not only liquids that are a one-state substance, but also liquids that include particles of a functional material composed of solid matter such as pigment or metallic particles, that are dissolved, dispersed, or mixed in a solvent. Representative examples of liquids include ink, as described in the above-described embodiments, liquid crystal, and the like. Here, ink encompasses various types of liquid-phase components, such as common water-based ink and oil-based ink, as well as gel ink and hot-melt ink. Specific examples of liquid jet apparatuses include liquid jet apparatuses that eject liquids that include, in a dispersed or dissolved form, materials such as electrode materials and color materials used in the manufacture of liquid crystal displays, EL (electroluminescence) displays, planar light emitting displays, color filters, and the like, for example. The liquid jet apparatus may also be a liquid jet apparatus that ejects living organic matter used in the manufacture of biochips, a liquid jet apparatus that is used as a precision pipette and ejects a liquid serving as a test sample, a printing apparatus, a microdispenser, or the like. Furthermore, the liquid jet apparatus may also be a liquid jet apparatus that ejects lubricant at a pinpoint in a precision machine such as a watch or a camera, or a liquid jet apparatus that ejects, onto a substrate, a transparent resin liquid such as an ultra-violet curable resin in order to form a minute hemispherical lens (optical lens) to be used in an optical communication element or the like. Also, the liquid jet apparatus may be a liquid jet apparatus that ejects an acidic or alkaline etching solution in order to etch a substrate, or the like. Also, the liquid container 14 may be a liquid container that contains a liquid to be ejected by these liquid jet apparatuses, and supplies the contained liquid to a liquid injection head included in a liquid jet apparatus.

### CROSS REFERENCE TO RELATED APPLICATIONS

The present application claims priority from Japanese Patent Application No. 2016-024691 filed on Feb. 12, 2016, the contents of which are hereby incorporated by reference into this application.

What is claimed is:

1. A liquid container comprising:
a liquid containing chamber configured to contain a liquid to be supplied to a liquid ejection head that ejects the liquid from a nozzle;
an air communication portion that allows an air introduction port for introducing air into the liquid containing chamber and an air communication port open to the atmosphere to be in communication;
a liquid inlet portion at which a liquid can be injected through an inlet opening that opens into the liquid containing chamber; and
a liquid discharging portion configured to discharge the liquid to the liquid ejection head from a liquid outlet provided on a bottom surface of the liquid containing chamber,
wherein the liquid containing chamber includes:
a viewing portion that is provided on a wall forming the liquid containing chamber and makes it possible to view a liquid surface in the liquid containing chamber from outside; and
a lower limit display portion that is provided on the viewing portion and serves as a reference for replenishing the liquid in the liquid containing chamber, and
the air introduction port is located at a position that is lower than a lower end of the inlet opening in the height direction, is the same as or lower than a position in the height direction of an end surface of the nozzle, and is the same as or higher than a position in the height direction of the lower limit display portion.

2. The liquid container according to claim 1, wherein the air communication portion includes a space portion having a predetermined volume.

3. The liquid container according to claim 1, wherein at least a portion of the viewing portion is located at a position that is lower than a lower end of the inlet opening in the height direction.

4. The liquid container according to claim 1, wherein the liquid containing chamber has an upper limit display portion that is provided on the viewing portion and serves as a reference for an upper limit of the liquid contained in the liquid containing chamber.

5. The liquid container according to claim 4, wherein the air introduction port is located at a position lower than the upper limit display portion in the height direction.

6. A liquid jet apparatus comprising:
the liquid container according to claim 1;
the liquid ejection head; and
a supply portion configured to supply the liquid contained in the liquid containing chamber to the liquid ejection head.

7. A liquid jet apparatus comprising:
the liquid container according to claim 2;
the liquid ejection head; and
a supply portion configured to supply the liquid contained in the liquid containing chamber to the liquid ejection head.

8. A liquid jet apparatus comprising:
the liquid container according to claim 3;
the liquid ejection head; and
a supply portion configured to supply the liquid contained in the liquid containing chamber to the liquid ejection head.

9. A liquid jet apparatus comprising:
the liquid container according to claim 4;
the liquid ejection head; and
a supply portion configured to supply the liquid contained in the liquid containing chamber to the liquid ejection head.

10. A liquid jet apparatus comprising:
the liquid container according to claim 5;
the liquid ejection head; and
a supply portion configured to supply the liquid contained in the liquid containing chamber to the liquid ejection head.
